(19) United States
(12) Patent Application Publication
(10) Pub. No.: US 2022/0055931 A1
(43) Pub. Date: Feb. 24, 2022

(54) METHODS OF REDUCING CALCITE FORMATION AND SOLUBILIZED METALS FROM AQUEOUS EFFLUENT STREAMS

(71) Applicant: Heritage Research Group, LLC, Indianapolis, IN (US)

(72) Inventors: Ralph E. Roper, JR., Carmel, IN (US); Anthony Rogers, Brownsburg, IN (US); Carina Vargas, Greenwood, IN (US); Anthony J. Kriech, Indianapolis, IN (US)

(73) Assignee: Heritage Research Group, LLC, Indianapolis, IN (US)

(21) Appl. No.: 17/453,196

(22) Filed: Nov. 2, 2021

Related U.S. Application Data
(63) Continuation of application No. PCT/US2020/031678, filed on May 6, 2020.
(60) Provisional application No. 62/844,210, filed on May 7, 2019.

(51) Int. Cl. C02F 5/06

(52) U.S. Cl. CPC C02F 5/06; C02F 2101/20

(57) ABSTRACT

Method of reducing calcite formation from solubilized calcium forms in aqueous effluent streams, including the reduction or removal of solubilized forms of nickel, selenium, sulfate, and magnesium.

### CROSS REFERENCE TO RELATED APPLICATIONS

This application is a continuation of International Application No. PCT/US2020/031678 filed on May 6, 2020, which claims the right of priority to U.S. Provisional Patent Application No. 62/844,210 filed on May 7, 2019, the entirety of both of which are hereby incorporated by reference in their entirety.

### FIELD

The present disclosure relates to the reduction or elimination of calcite formation from aqueous effluent streams, including the reduction or removal of undesirable solubilized minerals in such effluent streams. Exemplary uses include the treatment of water effluent streams from mining operations, including coal mining, which can result in the reduction or removal of solubilized forms of metals and oxyanions such as selenium, nickel, magnesium, sulfates and bicarbonates.

### BACKGROUND

Open pit coal mining operations can produce massive quantities of waste rock. The waste rock is typically dumped in adjacent waste rock piles that continue to grow for many decades throughout the life of the mine. Because typical waste rock piles are porous and uncapped, they are subject to “weathering” whereby the infiltration of precipitation and the advection of air result in chemical corrosion, i.e., mineralization, of the rock surfaces. This can result in the production of aqueous leachates that contain undesirable minerals that may be toxic to the environment, which result in effluent streams from the rock piles that feed into natural streams and rivers in the environment. Such undesired minerals may include selenates, selenites, sulfates and nitrates, as well as solubilized forms of magnesium, nickel, and calcium. Moreover, high concentrations of calcium can result in calcite (CaCO₃) “scaling” of the stream and river beds. Accordingly, there remains a need to implement improved methods of reducing calcite scaling from effluent streams, as well as reducing or removing the content of solubilized forms of nickel, selenium, sulfates, and nitrates.

### SUMMARY

Disclosed herein are methods of reducing calcite formation resulting from high concentrations of solubilized calcium forms in effluent streams, as well as the reduction or removal of solubilized metals and oxyanions from said effluent streams. In certain embodiments, the method comprises: identifying an aqueous effluent stream containing solubilized forms of selenium, nickel, calcium, magnesium, sulfate, and bicarbonate, each present at an initial concentration; contacting the aqueous effluent stream with a softening composition to provide a softened effluent stream, wherein the softened effluent stream comprises reduced concentrations of nickel, magnesium, and bicarbonate; precipitating at least one of ettringite or hydrocalumite from the softened effluent stream to provide a precipitated effluent stream, wherein the precipitated effluent stream comprises reduced concentrations of selenium and sulfate; and recarbonating the precipitated effluent stream to provide a recarbonated effluent, wherein the recarbonated effluent comprises a reduced concentration of calcium.

In some embodiments, the method comprises: identifying an aqueous effluent stream containing solubilized forms of selenium, nickel, calcium, magnesium, sulfate, and bicarbonate, each present at an initial concentration; contacting the aqueous effluent stream with a lime-soda composition to provide a softened effluent stream having a volume, wherein the softened effluent stream comprises reduced concentrations of calcium, nickel, magnesium, and bicarbonate; reducing the volume of the softened effluent stream to produce a concentrated brine stream and a cleansed permeate stream, wherein the concentrated brine stream contains the solubilized forms of sulfate and the selenium; and precipitating at least one of ettringite or hydrocalumite from the concentrated brine stream to provide a precipitated effluent stream, wherein the precipitated effluent stream comprises reduced concentrations of selenium and sulfate.

### BRIEF DESCRIPTION OF THE DRAWINGS

FIG. 1 shows a process flow diagram of one embodiment of the present disclosure, referred to as Method 1 herein.

FIG. 2 shows a process flow diagram of one embodiment of the present disclosure, referred to as Method 2 herein.

### DETAILED DESCRIPTION

As used in the present specification, the following words, phrases and symbols are generally intended to have the meanings as set forth below, except to the extent that the context in which they are used indicates otherwise. The following abbreviations and terms have the indicated meanings throughout:

“Aqueous effluent stream” generally refers to any water-based stream containing undesirable materials, including solubilized forms of metals (e.g., selenium and nickel) and/or oxyanions (e.g., sulfates and nitrates). Exemplary sources of aqueous effluent streams can include those derived from mining operations, include those derived from leachates permeating from mining waste rock piles.

“Initial concentration” refers to the aqueous concentration of a solubilized form of a component in an effluent stream.

“Reduced concentration” refers to the concentration of a solubilized form of a component in an effluent at a particular point of the relevant process being described, as compared to the component's initial concentration in the raw (initial) effluent stream.

Methods of reducing calcite formation resulting from high concentrations of solubilized calcium forms in effluent streams, as well as the reduction or removal of solubilized metals and oxyanions from said effluent streams. In certain embodiments, the method comprises: identifying an aqueous effluent stream containing solubilized forms of selenium, nickel, calcium, magnesium, sulfate, and bicarbonate, each present at an initial concentration; contacting the aqueous effluent stream with a softening composition to provide a softened effluent stream, wherein the softened effluent stream comprises reduced concentrations of nickel, magnesium, and bicarbonate; precipitating at least one of ettringite or hydrocalumite from the softened effluent stream to provide a precipitated effluent stream, wherein the precipitated effluent stream comprises reduced concentrations of selenium and sulfate; and recarbonating the precipitated effluent stream to provide a recarbonated effluent, wherein the recarbonated effluent comprises a reduced concentration of calcium.

In certain embodiments, the effluent stream will be derived from mining operations, such as leachates permeating from waste rock piles. The effluent will comprise undesirable amounts of solubilized components, which may be toxic to certain plants and animals in aquatic environments as the effluent streams flow into rivers and streams. For example, some effluent streams will comprise solubilized forms of metals such as selenium, nickel, magnesium, calcium, and sodium, as well as other solubilized forms of oxyanions such as sulfate, bicarbonate, and nitrate. Effluent streams may comprise a pH, for example, in which the bicarbonate form is favored (e.g., pH 8). An increase in the pH of the effluent stream under normal environmental conditions (e.g., pH>11) may result in conversion of the calcium bicarbonate into calcium carbonate (CaCO₃), resulting in a dramatic reduction in solubility of the calcium species and calcite plating of rocks and streambeds.

Thus, in certain embodiments it is desirable to reduce or eliminate calcite formation resulting from bicarbonate existence in the effluent stream. This may be accomplished by softening the effluent stream with lime, which will increase the pH of the effluent and conver the bicarbonate species to carbonate, precipitating calcium carbonate from the effluent for isolation of the solids, eliminating later release (and plating) into the environment. Thus, in certain embodiments the softening composition comprises Ca(OH)₂. Such softening of the effluent can also result in the significant reduction or elimination of solubilized nickel and magnesium present.

The resulting softened effluent stream may still contain undesirable amounts of selenium and sulfate, which will likely not be reduced in the softening step. In one embodiment, the selenium and sulfate may be reduced or eliminated by trapping it in hydrocalumite and/or ettringite. In certain embodiments, the precipitating comprises contacting the softened effluent stream with lime and at least one aluminate. In certain embodiments, this may comprise contacting the softened effluent stream with Ca(OH)₂ and NaAlO₂.

In certain embodiments, the aqueous effluent stream has a pH of less than 10.0, less than 9.0, or even less than 8.0, such as about 6.0 to about 8.0. Softening of the effluent may result in a softened effluent stream having a pH of at least 10.0 or at least 11.0, such as about 10.0 to about 11.0 or 11.5. Precipitation of the ettringite and/or hydrocalumite will result in a precipitated (solids removed) effluent stream having a pH of at least 12.0, such as about 11.0 to about 13.0.

In certain embodiments, the initial concentration of selenium is at least 100 ppb or at least 200 ppb, such as about 150 to about 250 ppb. In certain embodiments the initial concentration of nickel is at least 20 ppb, such as about 15 to about 30 ppb. In certain embodiments the initial concentration of magnesium is at least 100 ppb or at least 200 ppb, such as about 150 to about 300 ppb. In certain embodiments, the initial concentration of calcium is at least 150 ppb or 250 ppb, such as about 200 to about 400 ppb. In certain embodiments the initial concentration of sulfate is at least 500 ppb or at least 1000 ppb, such as about 800 to about 2000 ppb. In certain embodiments the aqueous effluent stream has an alkalinity of at least 200 ppb or at least 300 ppb, such as about 300 to about 600 ppb. In certain embodiments, the recarbonated effluent has a pH of less than 8.0, such as 7.0 or less, or about 5.5 to about 7.5.

In certain embodiments, the reduced concentration of selenium is less than 50 ppb or less than 25 ppb, such as about 0 to about 15 ppb. In certain embodiments, the reduced concentration of nickel is less than 20 or less than 10 ppb, such as about 0 to about 5 ppb. In certain embodiments the reduced concentration of magnesium is less than 25 ppb or less than 15 ppb, such as about 0 to about 10 ppb. In certain embodiments the reduced concentration of calcium is less than 150 ppb or less than 100 ppb, such as about 50 to about 100 ppb. In certain embodiments the reduced concentration of sulfate is less than 25 ppb or less than 10 ppb, such as about 0 to about 10 ppb. In certain embodiments, the softened effluent stream has an alkalinity of less than 50 ppb or less than 25 ppb, such as about 10 to about 50 ppb.

In certain embodiments, the softening composition consists essentially of Ca(OH)₂. In certain embodiments, recarbonation comprises the use of CO₂ or an acid such as HCl. In certain embodiments, precipitated effluent stream is substantially free of solubilized forms of nickel, magnesium, and sulfate. In certain embodiments, the precipitated effluent stream comprises less than 15 ppb or less than 10 ppb of solubilized forms of selenium.

In certain embodiments, the method comprises: identifying an aqueous effluent stream containing solubilized forms of selenium, nickel, calcium, magnesium, sulfate, and bicarbonate, each present at an initial concentration; contacting the aqueous effluent stream with a lime-soda composition to provide a softened effluent stream having a volume, wherein the softened effluent stream comprises reduced concentrations of calcium, nickel, magnesium, and bicarbonate; reducing the volume of the softened effluent stream to produce a concentrated brine stream and a cleansed permeate stream, wherein the concentrated brine stream contains the solubilized forms of sulfate and the selenium; and precipitating at least one of ettringite or hydrocalumite from the concentrated brine stream to provide a precipitated effluent stream, wherein the precipitated effluent stream comprises reduced concentrations of selenium and sulfate.

In certain embodiments, the cleansed permeate stream is substantially free of the solubilized forms of sulfate and selenium. In certain embodiments, the method further comprises recarbonating the cleansed permeate stream, in a manner similar to that previously described herein. In certain embodiments, both the cleansed permeate stream and the precipitated effluent stream can be recarbonated, either separately or via recombination of both streams.

Unlike the first method previously described above, the instant method may include the use of a lime-soda softening to effect near complete removal of all calcium species at the outset of the method, which may eliminate the solids production during later steps. In certain embodiments, the lime-soda composition comprises lime and soda ash. In certain embodiments, the lime-soda composition comprises Ca(OH)₂ and Na₂CO₃. Thus, in certain embodiments the softened effluent stream comprises solubilized forms of sulfate and selenium, which may take the form of solubilized Na₂SO₄ and Na₂O₄Se due to treatment with soda ash. In certain embodiments, precipitating comprises contacting the softened effluent stream with lime and at least one aluminate, such as previously described herein. In certain embodiments, reducing the volume of the softened effluent stream comprises nanofiltering the softened effluent stream to produce the concentrated brine containing the sulfate and the selenium.

In all of the foregoing examples, the compounds described may be useful alone, as mixtures, or in combination with other compounds, compositions, and/or materials.

### EXAMPLES

Calcite Considerations:

Effluent streams from raw mining (e.g., rock pile) water will contain solubilized forms of calcium, e.g., Ca(HCO₃)₂ at a pH of about 8. However, over time, increases in pH (e.g., above 10) will convert Calcium to CaCO₃ (calcite), which can cause calcite plating on stream and river beds. Simple spray irrigation will not address all plating, or other solubilized forms that need to be removed to detoxify the effluent (e.g., sulfate, magnesium, selenium, and nickel). Nitrates may be substantially removed by other pretreatment of the effluent streams, such as the methods disclosed in U.S. Provisional Patent Application No. 62/752,682, which is incorporated by reference in its entirety for all purposes.

Raw Water (Effluent) Sample:

concentrations of components in a lab sample, as compared to typical concentrations observed in the field from mining operations, are reported below in Table 1:

TABLE 1

| | Sample | | Typical Effluent | |
|---|---|---|---|---|
| Constituent | Concentration | | Concentrations | |
| Sulfate | 1,400 | mg/L | 800 | mg/L |
| Calcium | 365 | mg/L | 190 | mg/L |
| Magnesium | 245 | mg/L | 150 | mg/L |
| Selenium | 254 | ug/L | 160 | ug/L |
| Nickel | 39.2 | ug/L | 16.7 | ug/L |

| | | | |
|---|---|---|---|
| Nitrates | n/a | 6.8 | mg/L |

Initial Treatability Studies:

Cold Lime Softening (CLS) Process for combined calcite and nickel removal:

a. Add lime to elevate pH to around 10: Ca(OH)₂+Ca(HCO₃)₂=2CaCO₃+H₂O

b. Remove CaCO₃ solids (Ni comes out also).

c. Recarbonate with CO₂ (or HCl) to lower pH to produce slightly corrosive effluent

Test Results:
Calcium: 365 mg/L before; 175 mg/L after
Carbonate hardness: reduced to zero
Nickel: 39 ug/L before; below detectable levels (BDL) after

### Conclusion

Cold Lime Softening can solve:
calcite formation,
remove the nickel, and
enables decalcification of the streambeds.
No effect on sulfate toxicity issues
   Note: Selenium remains; non-carbonate hardness remains as CaSO₄ and MgSO₄; the source of all calcite (calcium bicarbonate) is removed.

Methods for combined calcite, nickel and selenium removal: methods include removal of selenium by substitution into ettringite and/or hydrocalumite compounds:

Ettringite Ca₆Al₂(OH)₁₂(SO₄)₃.26H₂O

Hydrocalumite Ca₄Al₂(OH)₁₂(OH)₂.6H₂O

The solubility limit for selenium in hydrocalumite is much lower than that for ettringite. Both compounds are components of Portland cement and/or calcium aluminate cement. Thus, a potential outlet for the by-product solids is to a cement plant.

Method 1:

precipitates these compounds from the softened (lime-treated) effluent stream. Typical results after filtration, reduces selenium to less than 10 ug/L, as noted below in Table 2:

TABLE 2

| | Third-Party | | Internal | |
|---|---|---|---|---|
| Sample | Testing | | Laboratory Testing | |
| Raw water | 253 | ug/L Se | 212 | ug/L Se |
| | | | (outside cal. Range) | |
| After | 239 | ug/L Se | 205 | ug/L Se |
| softening | | | (outside cal. Range) | |
| After Method | 8.7 | ug/L Se | 8.2 | ug/L |
| 1 treatment | | | | |

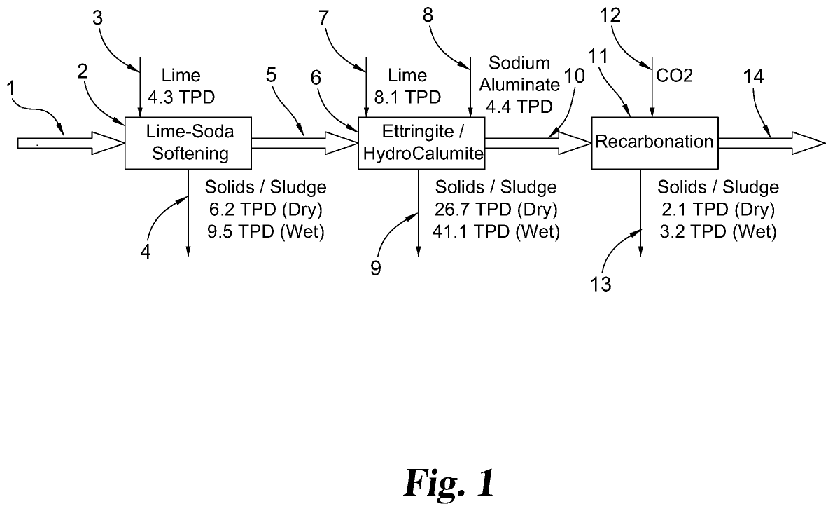

The process flowsheet is shown in FIG. 1, based on an assumed design flow of 1 million gallons per day (MGD) (3,780 M³/d). In the embodiment of FIG. 1, input raw water 1 (comprising a pH of 7.8, Se: 220 ppb, Ni: 28 ppb, SO₄: 1400 ppm, Ca: 320 ppm, Mg: 240 ppm, Na 18 ppm, Alkalinity: 400 ppm) is softened by a lime-soda softening step 2 wherein lime 3 is introduced and solids and/or sludge 4 are removed with output 5 (comprising pH 11, Se: 210 ppb, Ni: 0 ppb, SO₄: 1300 ppm, Ca: 530 ppm, Mg: 5 ppm, Na: 18 ppm, Alkalinity: 17 ppm) of this step introduced to a Ettringite/HydroCalumite step 6. Lime and Sodium Aluminate are input into the Ettringite/HydroCalumite step 6 and Solids/Sludge 9 are output during this step as well as output 10 (comprising pH 12.34, Se: 8.0 ppb, Ni: 0 ppb, SO₄: 0 ppm, Ca: 275 ppm, Mg: 0 ppm, Na: 300 ppm, Alkalinity: 17 ppm) which is input into a Recarbonation step 11 which uses carbon dioxide (CO₂) 12 and output 14 (comprising pH 6.5, Se: 8.0 ppb, Ni: 0 ppb, SO₄: 0 ppm, Ca: 62 ppm, Mg: 0 ppm, Na: 300 ppm) to a creek as well as Solids/Sludge 13.

### The Embodiment of Method 1 May Include the Following Features:

Process based on the precipitation of ettringite and hydrocalumite at a pH of around 12.3 by the addition of lime and sodium aluminate.
The precipitated effluent stream exhibits near complete removal of all calcium, magnesium, sulfate, nickel, and selenium (see the last lower box at the right of FIG. 1). The effluent is much like deionized water except for around 300 mg/L of sodium (from the sodium aluminate added)
Sulfate toxicity in the absence of sulfates would not be a concern because most of the sulfates are removed.
Future processing focused on high density (granular) solids for efficient dewatering and drying.
The amount of ettringite/hydrocalumite solids generated would be on the order of 27 tons per day (dry solids basis); TPD=tons per day; TPY=tons per year

Method 1 Mass Balance

| Reagents/Byproducts | TPD | TPY |
|---|---|---|
| Lime | 12.4 | 4,526 |
| Sodium Aluminate | 4.4 | 1,606 |
| Non-Selenium Solids | 8.3 | 3,030 |
| Selenium Solids | 26.7 | 9,746 |

*Assumes Solids on Dry Basis
*Based on Flowrate of 1 MGD

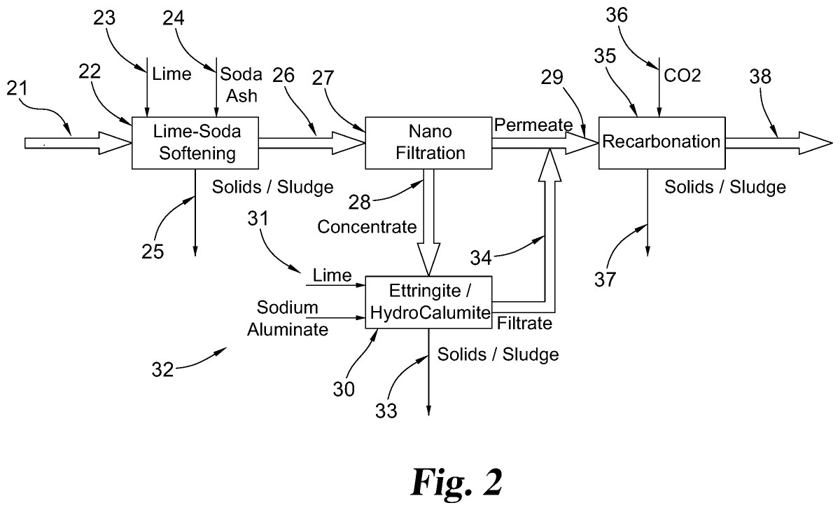

Method 2 seeks to mitigate several focus points in Method 1. The process flowsheet is shown in FIG. 2. In the embodiment of FIG. 1, input raw water 21 is input to a Lime-Soda softening process 22 in which Lime 23 and Soda Ash 24 are also input and Solids/Sludge 25 removed and the output 26 fed to a Nano Filtration step 27 with permeate 29 and concentrate 28 outputs. The Concentrate 28 output can be fed to an Ettringite/HydroCalumite step 30, where Lime 31 and Sodium Aluminate 32 are also input. The Ettringite/HydroCalumite step 30 outputs Solids/Sludge 33 and Filtrate 34, which Filtrate 34 can be fed to a Recarbonation step 35 along with Permeate 29. Carbon dioxide (CO₂) 36 can also be fed into the Recarbonation step 35 and Solids/Sludge 37 may be output as well as output 38 which can be fed to a creek.

### The Embodiment of Method 2 May Include the Following Features:

The raw effluent water is pretreated with lime-soda softening to removal all calcium and magnesium hardness so that the effluent only contains sodium sulfate and sodium selenate.
Nanofiltration is then applied to produce a sodium sulfate brine and a very clean permeate. Because calcium is removed prior to the nanofiltration step, it is probable that the reject water can be concentrated by a factor of 15 or more.
The selenium is then removed from the concentrate either by selective precipitation of hydrocalumite (low solid production) or jointly as combined ettringite plus hydrocalumite solids.
After precipitation, the slurry would go directly to a filter press for solids removal and dewatering, thereby avoiding intermediate clarifiers and thickeners.
A variant may be implemented in which hydrocalumite (for selenium removal) is selectively precipitated so that most of the sulfates stay in solution, which would greatly reduce chemical consumption and solids production rates
If selective precipitation of hydrocalumite is not feasible based on certain other process parameters, then solids generation rates from ettringite/hydrocalumite would be similar to those shown in FIG. 1 for Method 1.

### Conceptual Advantages of Method 2:

May be more adaptable to higher flowrates (dilute streams get concentrated by nanofiltration prior to the precipitation step).
Solids processing system may be less cumbersome as compared to Method 1.
May require much less chemicals and associated solids production if hydrocalumite can be selectively precipitated.

### Additional Embodiments

1. A method comprising:

identifying an aqueous effluent stream containing solubilized forms of selenium, nickel, calcium, magnesium, sulfate, and bicarbonate, each present at an initial concentration;

contacting the aqueous effluent stream with a softening composition to provide a softened effluent stream, wherein the softened effluent stream comprises reduced concentrations of nickel, magnesium, and bicarbonate;

precipitating at least one of ettringite or hydrocalumite from the softened effluent stream to provide a precipitated effluent stream, wherein the precipitated effluent stream comprises reduced concentrations of selenium and sulfate; and

recarbonating the precipitated effluent stream to provide a recarbonated effluent, wherein the recarbonated effluent comprises a reduced concentration of calcium.

2. The method of embodiment 1, wherein the softening composition comprises lime.
3. The method of any one of the preceding embodiments, wherein the softening composition comprises Ca(OH)₂.
4. The method of any one of the preceding embodiments, wherein the precipitating comprises contacting the softened effluent stream with lime and at least one aluminate.
5. The method of any one of the preceding embodiments, wherein the precipitating comprises contacting the softened effluent stream with Ca(OH)₂ and NaAlO₂.
6. The method of any one of the preceding embodiments, wherein contacting the aqueous effluent stream with the softening composition converts the solubilized form of the bicarbonate into a less-soluble or insoluble form of a carbonate.
7. The method of any one of the preceding embodiments, wherein the solubilized form of the bicarbonate comprises Ca(HCO₃)₂.
8. The method of any one of embodiments 6-7, wherein the less soluble or insoluble form of the carbonate comprises CaCO₃.
9. The method of any one of the preceding embodiments, wherein the aqueous effluent stream has a pH of less than 10.0.
10. The method of any one of the preceding embodiments, wherein the aqueous effluent stream has a pH of less than 9.0.
11. The method of any one of the preceding embodiments, wherein the aqueous effluent stream has a pH of less than 8.0.
12. The method of any one of the preceding embodiments, wherein the softened effluent stream has a pH of at least 10.0.
13. The method of any one of the preceding embodiments, wherein the softened effluent stream has a pH of at least 11.0.
14. The method of any one of the preceding embodiments, wherein the softened effluent stream has a pH of about 10.0 to about 11.0.
15. The method of any one of the preceding embodiments, wherein the precipitated effluent stream has a pH of greater than 11.0.
16. The method of any one of the preceding embodiments, wherein the precipitated effluent stream has a pH of at least 12.0.
17. The method of any one of the preceding embodiments, wherein the precipitated effluent stream has a pH of about 11.0 to about 13.0.
18. The method of any one of the preceding embodiments, wherein the initial concentration of selenium is at least 100 ppb.
19. The method of any one of the preceding embodiments, wherein the initial concentration of selenium is at least 200 ppb.
20. The method of any one of the preceding embodiments, wherein the initial concentration of selenium is about 150 to about 250 ppb.
21. The method of any one of the preceding embodiments, wherein the initial concentration of nickel is at least 20 ppb.
22. The method of any one of the preceding embodiments, wherein the initial concentration of nickel is about 15 to about 30 ppb.
23. The method of any one of the preceding embodiments, wherein the initial concentration of magnesium is at least 100 ppb.
24. The method of any one of the preceding embodiments, wherein the initial concentration of magnesium is at least 200 ppb.
25. The method of any one of the preceding embodiments, wherein the initial concentration of magnesium is about 150 to about 300 ppb.
26. The method of any one of the preceding embodiments, wherein the initial concentration of calcium is at least 150 ppb.
27. The method of any one of the preceding embodiments, wherein the initial concentration of calcium is at least 250 ppb.
28. The method of any one of the preceding embodiments, wherein the initial concentration of calcium is about 200 to about 400 ppb.
29. The method of any one of the preceding embodiments, wherein the initial concentration of sulfate is at least 500 ppb.
30. The method of any one of the preceding embodiments, wherein the initial concentration of sulfate is at least 1000 ppb.
31. The method of any one of the preceding embodiments, wherein the initial concentration of sulfate is about 800 to about 2000 ppb.
32. The method of any one of the preceding embodiments, wherein the aqueous effluent stream has an alkalinity of at least 200 ppb.
33. The method of any one of the preceding embodiments, wherein the aqueous effluent stream has an alkalinity of at least 300 ppb.
34. The method of any one of the preceding embodiments, wherein the aqueous effluent stream has an alkalinity of about 300 to about 600 ppb.
35. The method of any one of the preceding embodiments, wherein the recarbonated effluent has a pH of less than 8.0.
36. The method of any one of the preceding embodiments, wherein the recarbonated effluent has a pH of 7.0 or less.
37. The method of any one of the preceding embodiments, wherein the recarbonated has a pH of about 5.5 to about 7.5.
38. The method of any one of the preceding embodiments, wherein the reduced concentration of selenium is less than 50 ppb.
39. The method of any one of the preceding embodiments, wherein the reduced concentration of selenium is less than 25 ppb.
40. The method of any one of the preceding embodiments, wherein the reduced concentration of selenium is about 0 to about 15 ppb.
41. The method of any one of the preceding embodiments, wherein the reduced concentration of nickel is less than 20 ppb.
42. The method of any one of the preceding embodiments, wherein the reduced concentration of nickel is less than 10 ppb.
43. The method of any one of the preceding embodiments, wherein the reduced concentration of nickel is about 0 to about 5 ppb.
44. The method of any one of the preceding embodiments, wherein the reduced concentration of magnesium is less than 25 ppb.
45. The method of any one of the preceding embodiments, wherein the reduced concentration of magnesium is less than 15 ppb.
46. The method of any one of the preceding embodiments, wherein the reduced concentration of magnesium is about 0 to about 10 ppb.
47. The method of any one of the preceding embodiments, wherein the reduced concentration of calcium is less than 150 ppb.
48. The method of any one of the preceding embodiments, wherein the reduced concentration of calcium is less than 100 ppb.
49. The method of any one of the preceding embodiments, wherein the reduced concentration of calcium is about 50 to about 100 ppb.
50. The method of any one of the preceding embodiments, wherein the reduced concentration of sulfate is less than 25 ppb.
51. The method of any one of the preceding embodiments, wherein the reduced concentration of sulfate is less than 10 ppb.
52. The method of any one of the preceding embodiments, wherein the reduced concentration of sulfate is about 0 to about 10 ppb.
53. The method of any one of the preceding embodiments, wherein the softened effluent stream has an alkalinity of less than 50 ppb.
54. The method of any one of the preceding embodiments, wherein the softened effluent stream has an alkalinity of less than 25 ppb.
55. The method of any one of the preceding embodiments, wherein the softened effluent stream has an alkalinity of about 10 to about 50 ppb.
56. The method of any one of the preceding embodiments, wherein the softening composition consists essentially of Ca(OH)₂.
57. The method of any one of the preceding embodiments, wherein recarbonation comprises the use of CO₂ or an acid.
58. The method of any one of the preceding embodiments, wherein recarbonation comprises the use of HCl.
59. The method of any one of the preceding embodiments, wherein the precipitated effluent stream is substantially free of solubilized forms of nickel, magnesium, and sulfate.
60. The method of embodiment 59, wherein the precipitated effluent stream comprises less than 15 ppb of solubilized forms of selenium.
61. The method of embodiment 59, wherein the precipitated effluent stream comprises less than 10 ppb of solubilized forms of selenium.
62. A method comprising:

identifying an aqueous effluent stream containing solubilized forms of selenium, nickel, calcium, magnesium, sulfate, and bicarbonate, each present at an initial concentration;

contacting the aqueous effluent stream with a lime-soda composition to provide a softened effluent stream having a volume, wherein the softened effluent stream comprises reduced concentrations of calcium, nickel, magnesium, and bicarbonate;

reducing the volume of the softened effluent stream to produce a concentrated brine stream and a cleansed permeate stream, wherein the concentrated brine stream contains the solubilized forms of sulfate and the selenium; and

precipitating at least one of ettringite or hydrocalumite from the concentrated brine stream to provide a precipitated effluent stream, wherein the precipitated effluent stream comprises reduced concentrations of selenium and sulfate.

63. The method of embodiment 62, wherein the cleansed permeate stream is substantially free of the solubilized forms of sulfate and selenium.
64. The method of any one of embodiments 62-63, further comprising recarbonating the cleansed permeate stream.
65. The method of any one of embodiments 62-64, further comprising recarbonating the precipitated effluent stream.
66. The method of any one of embodiments 63-65, wherein the cleansed permeate stream and the precipitated effluent stream are combined, and the recarbonating is conducted in the combined cleansed permeate stream and the precipitated effluent stream.
67. The method of any one of embodiments 63-66, wherein recarbonation comprises the use of CO₂ or an acid.
68. The method of any one embodiments 63-67, wherein recarbonation comprises the use of HCl.
69. The method of any one of embodiments 62-68, wherein the lime-soda composition comprises lime and soda ash.
70. The method of any one of embodiments 62-69, wherein the lime-soda composition comprises Ca(OH)₂ and Na₂CO₃.
71. The method of any one of embodiments 62-69, wherein the softened effluent stream comprises solubilized forms of sulfate and selenium.
72. The method of any one of embodiments 62-70, wherein the softened effluent stream comprises solubilized Na₂SO₄ and Na₂O₄Se.
73. The method of any of embodiments 62-72, wherein the precipitating comprises contacting the softened effluent stream with lime and at least one aluminate.
74. The method of any of any of embodiments 62-73, wherein the precipitating comprises contacting the softened effluent stream with Ca(OH)₂ and NaAlO₂.
75. The method of any of embodiments 62-74, wherein reducing the volume of the softened effluent stream comprises nanofiltering the softened effluent stream to produce the concentrated brine containing the sulfate and the selenium.

1. A method comprising:
identifying an aqueous effluent stream containing solubilized forms of selenium, nickel, calcium, magnesium, sulfate, and bicarbonate, each present at an initial concentration;
contacting the aqueous effluent stream with a softening composition to provide a softened effluent stream, wherein the softened effluent stream comprises reduced concentrations of nickel, magnesium, and bicarbonate;
precipitating at least one of ettringite or hydrocalumite from the softened effluent stream to provide a precipitated effluent stream, wherein the precipitated effluent stream comprises reduced concentrations of selenium and sulfate; and
recarbonating the precipitated effluent stream to provide a recarbonated effluent, wherein the recarbonated effluent comprises a reduced concentration of calcium.

2. The method of claim 1, wherein the softening composition comprises lime.

3. The method of claim 2, wherein the softening composition comprises Ca(OH)₂.

4. The method of claim 1, wherein the precipitating comprises contacting the softened effluent stream with lime and at least one aluminate.

5. The method of claim 1, wherein the precipitating comprises contacting the softened effluent stream with Ca(OH)₂ and NaAlO₂.

6. The method of claim 1, wherein contacting the aqueous effluent stream with the softening composition converts the solubilized form of the bicarbonate into a less-soluble or insoluble form of a carbonate.

7. The method of claim 1, wherein the solubilized form of the bicarbonate comprises Ca(HCO₃)₂.

8. The method of claim 6, wherein the less soluble or insoluble form of the carbonate comprises CaCO₃.

9. The method of claim, wherein the aqueous effluent stream has a pH of less than 10.0.

10. The method of claim 9, wherein the aqueous effluent stream has a pH of less than 9.0.

11. The method of claim 10, wherein the aqueous effluent stream has a pH of less than 8.0.

12. The method of claim 1, wherein the softened effluent stream has a pH of at least 10.0.

13. The method of claim 12, wherein the softened effluent stream has a pH of at least 11.0.

14. The method of claim 1, wherein the softened effluent stream has a pH of about 10.0 to about 11.0.

15. The method of claim 1, wherein the precipitated effluent stream has a pH of greater than 11.0.

16. The method of claim 15, wherein the precipitated effluent stream has a pH of at least 12.0.

17. The method of claim 1, wherein the precipitated effluent stream has a pH of about 11.0 to about 13.0.

18. The method of claim 1, wherein the initial concentration of selenium is at least 100 ppb.

19. The method of claim 18, wherein the initial concentration of selenium is at least 200 ppb.

20. The method of claim 1, wherein the initial concentration of selenium is about 150 to about 250 ppb.

21-75. (canceled)
